(19) United States
(12) Patent Application Publication
(10) Pub. No.: US 2005/0065244 A1
(43) Pub. Date: Mar. 24, 2005

(54) Alkanolamine polymer salt additives for creping of fibrous webs

(76) Inventor: Duy T. Nguyen, Austin, TX (US)

Correspondence Address: HUNTSMAN LLC, P. O. Box 15730, Austin, TX, 78761, US

(21) Appl. No.: 10/927,204

(22) Filed: Dec. 3, 2004

Related U.S. Application Data
(62) Division of application No. 10/370,156, filed on Feb. 19, 2003, now abandoned.

(51) Int. Cl. C08L 1/00

(52) U.S. Cl. 524/35; 524/555; 524/556

(57) ABSTRACT

The present invention provides compositions a useful in the creping of paper products such as facial tissue and bathroom tissue. The compositions comprise an alkanolamine salt of a styrene-methacrylic acid co-polymer. According to a process according to the invention, a composition of the invention is contacted with the dryer cylinder in a creping process.

### CROSS-REFERENCES TO RELATED APPLICATIONS

This Application claims priority to, and is a divisional application of U.S. patent application Ser. No. 10/370,156 filed Feb. 19, 2003.

### FIELD OF THE INVENTION

This invention relates generally to creped paper. More particularly, it relates to creped tissue paper such as facial tissue and bathroom tissue products, and processes for producing such products and other forms of crepe paper.

### DESCRIPTION OF THE RELATED ART

Tissue products such as facial tissues, toilet tissues and absorbent towels are well-known in the art and widely used. The softness properties of such paper products is of utmost importance, and can be conferred upon paper via many mechanical and chemical means. “Creping” and “Through-Air-Dry” (TAD) usually refer to the mechanical means for achieving softness, and the chemical means are carried out by inclusion of de-bonders and/or softeners during the normal processing of pulp and paper used to make such products. In addition to conferring softness properties, creping processes generally increase the absorbency of such paper products by increasing the void volume in the sheet.

In a popular conventional process of making tissue, the wet web (60-65% moisture) is conveyed to the dryer by means of a felt, and is subsequently transferred to a drying cylinder which is commonly referred to as a “Yankee” dryer by those skilled in the art, at a pressure nip. The surface temperature of the dryer is often very near 100° C., and machine speeds in the range of 800 to 2000 m/min are common. Creping paper involves spraying the dryer cylinder with a suitable amount of adhesive via a spray boom at its 6 o'clock position (FIG. 1, below) and pressing the paper web against the surface of the dryer cylinder. The sheet is dried as it travels around the circumference of the dryer and is subsequently removed from the dryer surface by a metal “doctor” blade. This action ruptures some fiber-to-fiber bonds within the webs, and causes the web to expand somewhat and become soft.

At the time of creping, the sheet contains about 5% moisture. A loop structure within the paper called a microfold is formed as the doctor blade removes the sheet. Subsequently, other loops or microfolds form on top of the first one creating a pile or macrofold. The degree of the effects of the creping process depends on factors such as the strength of the adhesive (i.e., the degree of adhesion of the sheet to the dryer), the difference in speed between the Yankee dryer and the final selection of the paper machine, doctor blade geometry, and the raw fiber materials used in the stock. Inadequate adhesion of the sheet to the dryer surface will result in inferior quality, and possible problems at the reel such as wrinkling, Holdovers, and weaved edges.

An effective chemical creping aid must provide a uniform tacky coating across the entire face of the dryer so that the sheet is evenly adhered to the surface of the dryer. High levels of adhesion of the paper web to the dryer will cause the web to dry faster, enabling higher energy efficiency and higher speed operation. In addition to proper adhesion, a coating of a thin layer of organic and inorganic material deposited on the dryer by the action of the evaporation of the water serves to protect the dryer and blade surfaces from excessive wear. While some amount of buildup of the creping aid on the surface is necessary, excessive buildup can cause humps, wrinkles, or holes in the sheet.

Another important characteristic of an effective creping aid is that it be re-wettable. “Re-wettability” refers to the ability of the adhesive film remaining on the Yankee dryer surface to be activated by absorbing water from the fresh application as well as from the moisture which is released from the fibrous structure at the pressure roll nip of the Yankee dryer. Re-wettability is an important property of an effective creping aid as only very small amounts of adhesive are added per revolution of the Yankee dryer. A schematic of such a setup is depicted in FIG. 1.

Recently, drying of the web by the “throughdrying” or “through-air” method has received considerable attention because it improves bulk and softness of the web during drying. In such a process, hot air is passed through the web to effect partial drying prior to pressing the web against the Yankee dryer to finish the drying process. However, one disadvantage of partial drying prior to the dryer is that the resulting partially dried web requires the addition of a creping adhesive to the surface of the dryer in order to provide adequate adhesion of the web to the cylinder necessary to obtain proper creping. This was not required in some conventional processes in which the high moisture content of the web provides sufficient adhesion of the web to the dryer.

Polyamide polyamine epichlorohydrin (PAE) resins derived from secondary amine have been found to be effective creping aids in paper machine systems using the conventional wet press section. However, they are not efficacious in the paper machine systems which employ through-air drying. Creping aids derived from polyaminoamide (“PAA”) secondary amine resin chemistry are also efficacious; however, insomuch as they are thermosetting, they have a tendency to cure on the heated surface of the dryer. As a result, the coating formed on the dryer using through-air drying tends to be brittle, and exhibits poor adhesion of the sheet to the dryer surface. Additionally, the thermosetting wet strength resins will crosslink with creping aids which contain a secondary amine backbone, causing the formation of a hard coating on the surface of the dryer with poor adhesion characteristics. As a result, specialized thermoplastic resins have been developed to diminish these problems.

Poly(aminoamide)-epichlorohydrin (PAE with secondary amine) resins are commonly used as creping aids, as described in U.S Pat. Nos. 5,388,807, 5,786,429, 5,902,862 and Canada Patent No. 979,579, the entire contents of each of which each of these, and all other patent documents cited in this specification, are herein expressly incorporated by reference thereto. These resins prove to exhibit good adhesion; however, since they are thermosetting, upon heating they will eventually cross-link and irreversibly harden. As a result, the addition of moisture is no longer able to soften the coating sufficiently to optimally bond with the web at the pressure roll nip. In other words, their re-wettability is poor. To improve the wettability, PAE is combined with polyvinyl alcohol (PVA), and a synergy is observed for the mixture (U.S. Pat. No. 4,501,640 and U.S. Pat. No. 4,528,316). PVA is known to exhibit a re-wet mechanism and has been claimed as a creping aid (U.S Pat. No. 3,926,716 ); however, PVA alone is not as effective as PAE. Since PAE resins contain a relatively high content of chloride ion, they eventually will corrode the dryer surface. Another problem associated with PAE resins is the coating buildup.

U.S. Pat. No. 5,179,150 discloses a creping composition comprising (a): a thermosetting glyoxylated vinyl amide polymer (e.g., glyoxylated acrylamide/DADAMAC co-polymer) and (b) polyvinyl alcohol.

U.S. Pat. No. 5,187,219 discloses a thermosetting creping aid comprising glyoxylated vinyl amide polymers (e.g., glyoxylated acrylamide/DADAMAC co-polymer) in combination with polyols as plasticizers. The polylols are compatibles with the polymers and they form a uniform coating.

U.S. Pat. No. 6,214,932 discloses a creping adhesive comprising a mixture of polyamide derived from a dibasic acid (e.g., adipic acid) and polyalkylene polyamine (diethylene triamine) and polyvinyl alcohol and reacting this polymer mixture with epichlorohydrin. This particular crepe aid exhibits better adhesion than the physical blends of polyamide resin with polyvinyl alcohol as disclosed in U.S. Pat. Nos. 4,501,640, 4,528,316, 4,784,439, and 4,788,243.

U.S. Pat. No. 5,490,903 discloses a creping adhesive which contains a blend of an ethoxylated acetylenic diol surfactant, polyaminoamide, and polyvinyl alcohol. The dynamic surface tension is shown to be less than 40 dynes/cm at 5 bubbles/sec. As a result, more uniform coating is achieved, as described therein.

U.S. Pat. No. 5,833,806 discloses a creping composition which contains (a) a polyamine epichlorohydrin or polyaminoamide epichlorohydrin resin and (b) a release agent that is a plasticizer for the above resin, e.g., ethylene glycol, triethanolamine.

U.S. Pat. Nos. 4,684,439 and 4,788,243 disclose an improved wettable creping adhesive comprises a mixture of PVA and water soluble thermoplastic polyamide resin which is the reaction product of a polyalkylene polyamine (e.g., diethylene triamine), a saturated aliphatic dibasic carboxylic acid (e.g., adipic.acid), and a poly(oxyethylene) diamine (e.g., JEFFAMINE® ED 600 polyetheramine).

U.S. Pat. No. 5,370,773 discloses a creping adhesive comprising (a) a non-self crosslinkable polymer (e.g., polyvinyl alcohol); (b) multivalent cation crosslinking agents; and (c) phosphate surfactant as an internal lubricant to improve creping blade wear and protect the dryer from corrosion.

U.S. Pat. No. 4,440,898 discloses a creping adhesive for use in a throughdrying process comprising mixture of an ethylene oxide/propylene oxide co-polymer and a high molecular weight thermoplastic polymer selected from the group of polyvinyl alcohol and polyvinyl pyrrolidone.

U.S. Pat. No. 4,886,579 discloses a method of applying the creping adhesive comprising 10-100% by weight of a polymer or co-polymer having a glass transition temperature greater than 50° C. (e.g., polymethyl acrylate) to the web prior to its contact with the creping surface.

U.S. Pat. No. 4,994,146 discloses a creping method in which a water soluble polyacid such as polyacrylic acid (not polyacrylate), styrene maleic acid co-polymer, mixture of polyvinyl alcohol and polyacrylic acid is applied to the surface of the cylinder and a second water soluble polymer selected from polyether (e.g., polyethylene oxide), polyacrylamide is applied to the surface of the web. When the two components are in contact at the pressure roll nip, an adhesive complex is formed.

U.S. Pat. No. 5,234,547 teaches a creping adhesive which contains an anionic co-polymer of acrylamide and acrylic acid.

While the materials and processes of previous workers in this field have attempted to provide materials which satisfy all of the requirements of the processors of crepe papers, each is not without its own shortcomings, the most common of which are cost, corrosiveness to equipment, and ease of use and maintenance of mill equipment.

The co-polymers of the present invention have a low glass transition temperature, are not corrosive to the dryer or other equipment, are relatively low in cost to produce, and have been found to be extremely effective at enhancing the quality of crepe paper, which makes them the model materials for this employment as of this writing.

### BRIEF DESCRIPTION OF THE DRAWINGS

In the annexed drawings:

FIG. 1 shows a schematic view of a creping process according to the prior art; and

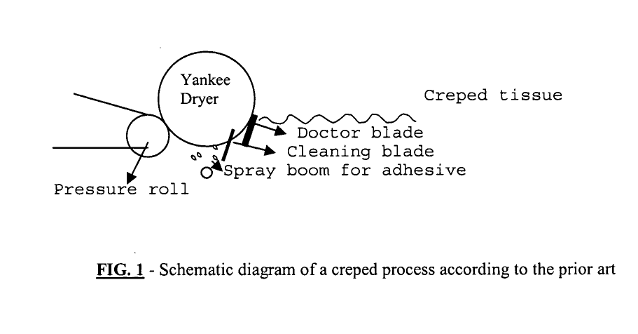

FIG. 2 shows the measured adhesion force required to remove paper samples substrates treated with various treatments.

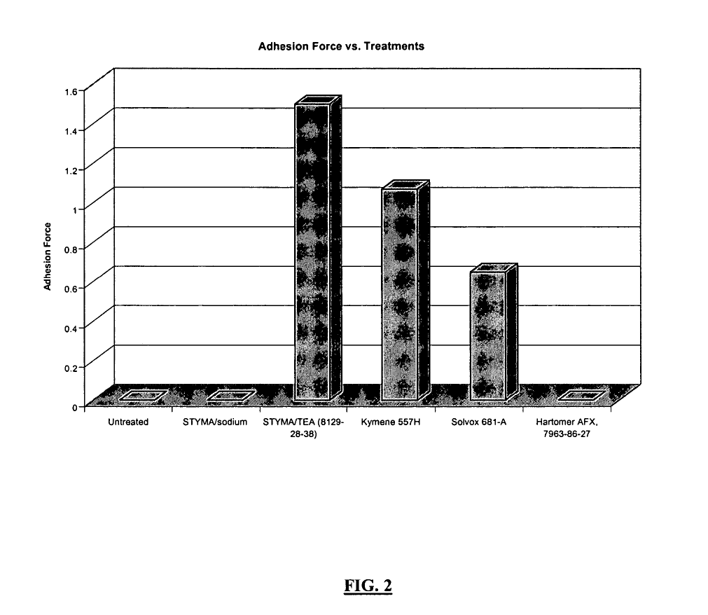

### SUMMARY OF THE INVENTION

The present invention provides a composition of matter useful in the creping of paper products such as facial tissues and bathroom tissue which comprises: a) water; and b) an alkanolamine salt of a styrene-methacrylic acid co-polymer. The salt is preferably made by combining an alkanolamine with a styrene-methacrylic acid co-polymer. The co-polymer has a styrene content in the range of between 10.00% and 90.00% by weight based upon the total weight of said co-polymer, and a weight-average molecular weight in the range of between 3,000 and 500,000. According to one form of the invention, the alkanolamine is selected from the group consisting of: mono-alkanolamines; di-alkanolamines; and tri-alkanolamines. The alkanolamine preferably includes at least one C₁ to C₁₄ alkyl chain bonded to a nitrogen atom, wherein the alkyl chain further includes at least one hydroxy group bonded to one of the carbon atoms in the alkyl chain. Two or three such “hydroxy alkyl chains” may be bonded to the nitrogen atom in alternate forms of the invention.

In another embodiment, the present invention comprises a composition as previously stated, and further comprises cellulose fibers.

The invention also provides a process for creping tissue paper, comprising: contacting an adhesive to the dryer used in the manufacture of tissue paper, wherein the adhesive comprises an aqueous dispersion comprising any amount of water in the range of 60% to 99.9% and from about 40% to about 0.1% solids. The solids comprise an alkanolamine salt of a styrene-methacrylic acid co-polymer having a styrene content in the range of between 10.00% and 90.00% by weight based upon the total weight of the co-polymer, and a weight-average molecular weight in the range of between 3,000 and 500,000. The alkanolamine is selected from the group consisting of: mono-alkanolamines; di-alkanolamines; and tri-alkanolamines. The alkanolamine includes at least one C₁ to C₁₄ alkyl chain bonded to a nitrogen atom, wherein the alkyl chain further includes at least one hydroxy group bonded to one of the carbon atoms in the alkyl chain. A tissue paper web is caused to be adhered to the surface of said dryer; and is subsequently removed from the dryer via a doctor blade.

### DETAILED DESCRIPTION OF THE INVENTION

The present invention is directed at compositions of matter useful as creping additives. A composition according to a preferred form of the invention comprises an amine salt of styrene-methacrylic acid co-polymer, in which the co-polymer has a styrene content from about 10% to about 90% by weight based on the total weight of the co-polymer. The molecular weight of the co-polymer is preferably in the range of 3000 to 500,000 weight-average molecular weight (all molecular weights disclosed in this specification are weight-average molecular weights, unless otherwise noted), and the co-polymer has a glass transition temperature which is below 100° C. Compositions according to one preferred form of the invention comprise an amine salt of styrene-methacrylic acid co-polymer in which the co-polymer has a styrene content between about 10 and 90 percent by weight based on the total weight of the polymer. According to one preferred form of the invention, the total amount of applied creping adhesive is from about 40 grams/ton to about 5 kilograms/ton of dry weight creping adhesive, based on the dry weight of the paper web.

The invention also includes a process for creping tissue paper, which process comprises: a) applying an adhesive which comprises an aqueous dispersion comprising from about 75% to about 99.9% water and from about 25% to about 0.1% solids to a dryer, wherein said solids comprise an amine salt of styrene-methacrylic acid co-polymer; b) pressing a tissue paper web against the dryer to adhere the web to the surface of the dryer; and c) removing the web from the dryer via a doctor blade.

### Amine Salt of Styrene/Methacrylic Acid Co-Polymer

The preparation of styrene/methacrylic acid co-polymers is known in the art. One method for their preparation involves charging a 3-necked 1 L flask equipped with a mechanical stirrer and heating mantle with 209.46 g of isopropanol and 200.86 g of water, and heating under mild agitation with a slow nitrogen purge of the headspace, until a gentle reflux is achieved, which occurs at about 80° C. A first stream comprising 24.74 g of a 14.3% aqueous sodium persulfate solution is slowly added to the content of the refluxing contents of the flask, simultaneously with a second stream comprising a liquid mixture of 70.68 g of styrene and 70.68 g of methacrylic acid, over the course of about 2 hours. Following the addition, the temperature is maintained at reflux for an additional 2 hours to ensure completeness of reaction. Then, an additional 15.4 g of 14.3% sodium persulfate is added, and the temperature maintained at reflux for one additional hour to digest residual quantities of the monomers.

To prepare an amine salt of a co-polymer produced as above, namely the triethanol amine salt (TEA), the flask from the above containing the crude reaction product mixture is set up for distillation by affixing a condenser and head thereto. The flask is heated until the azeotrope of isopropanol and water begins to distill, at which time 123.57 g of TEA is slowly added to the flask during the distillation at a rate which is approximately equal to the rate at which the azeotrope is being distilled. The reaction is completed when the temperature reaches 100° C., after which point the flask is cooled to 50° C. and 100 g of water is added, which lowers the viscosity of the mixture.

In the above-described method for preparing a styrene-methacrylic acid co-polymer, the styrene/methacrylic acid ratio is about 50:50. Other ratios of styrene/methacrylic acid in the range of 10:90 to 90:10 by weight are suitable for providing co-polymers useful in the present invention and are readily achievable by those of ordinary skill in the art by altering the ratio of monomers.

The weight average molecular weight of a styrene/methacrylic acid co-polymer useful in accordance with the present invention is in the range of about 1,000 to about 500,000, with molecular weights having any value in the range of 2,000 to 400,000 being preferred, and with molecular weights having any value in the range of about 3,000 to about 300,000 being most preferred. The molecular weight is controlled by the concentration of the initiator, and the chain transfer agent, as is known in the art. While in the present invention it is most preferred during the preparation of our polymer(s) that the chain transfer agent is isopropanol and the initiator is persulfate ion, we realize that other chain transfer agents and initiators are known to those skilled in the art are useful in preparing such polymers as those described herein; hence this should in no way be construed as delimitive of the present invention.

### Adhesion Test

Materials useful as adhesives in creping paper need to function as adhesives, to a balanced degree. A suitable test for evaluating the adhesiveness of such agents involves heating a plate of 2×4 inch stainless steel on a hot plate to about 120° C., and then applying a 76 micron adhesive coating to the test plate using a suitable wire rod. A piece of filter paper is then quickly and carefully applied to the film and rolled 10 times with a paint roller to achieve uniform contact between the paper, adhesive and metal surface. Subsequent heating of the plate to 120° C. for 2 min, the metal coupon with the attached paper test strip is then removed and cooled to room temperature, after which the paper is peeled at an angle of 90° using an INSTRON® peel strength tester. Duplicate runs were made for each product, and the average values were calculated. A plot showing the average adhesion (lb/in) for various products is set forth below.

Interestingly, when compared to the sodium salt of styrene-methacrylic acid co-polymers (“STYMA”), the amine salt(s) of STYMA (and especially that of TEA) is much more efficacious, as reflected by much higher adhesion values for the latter. STYMA with amine salt also appeared to be more effective than the polyamide-epihalohydrin resins such as KYMEN® 557 H and SOLVOX® 681-A of the prior art (see for example U.S Pat. Nos. 5,388,807, 5,786,429, 5,902,862, and Canada Patent No. 979,579). HARTOMER® AFX is a blend of STYMA sodium salt, sorbitol and polyvinyl alcohol.

The glass transition temperature of the polymer also plays an important role in obtaining good creping properties. The glass transition temperature for an amorphous polymer is the temperature at which the material undergoes a phase change from being a glassy or brittle state to a plastic or rubbery state. To obtain adequate adhesion, the polymer's glass transition temperature has to be below the operating temperature, which in the case of paper creping processes is about 100° C. Above the glass transition temperature, sufficient contact between the adhesive and the dryer surface is achieved, while below the glass transition temperature, the polymer is too brittle and hard to function well. The glass transition temperatures of various crepe aids are listed in Table 1:

TABLE 1
Glass Transition Temperatures of Various Crepe Aids

| Product | T_{g} (° C.) |
|---|---|
| STYMA (50:50) + TEA | 24 |
| STYMA (50:50) + NaOH | >150 |
| HARTOMER ® AFX | >150 |
| SOLVOX ® 681-A | 88 |
| Polyvinyl alcohol (AIRVOL ® 540) | 68 |
| KYMENE ® 557 H | 58 |

As can be seen, STYMA+TEA has the glass transition temperature much lower than STYMA+NaOH. This may be one of the reasons for the excellent performance of the former.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. Accordingly, the presently disclosed invention is intended to cover all such modifications and alterations, and is limited only by the scope of the claims which follow.

1) A process for creping tissue paper, comprising:
a) contacting an adhesive to the dryer used in the manufacture of tissue paper, wherein said adhesive comprises an aqueous dispersion comprising any amount of water in the range of 60% to 99.9% and from about 40% to about 0.1% solids, wherein the solids comprise an alkanolamine salt of a styrene-methacrylic acid co-polymer having a styrene content in the range of between 10.00% and 90.00% by weight based upon the total weight of said co-polymer, and a weight-average molecular weight in the range of between 3,000 and 500,000, wherein said alkanolamine is selected from the group consisting of: mono-alkanolamines; di-alkanolamines; and tri-alkanolamines, said alkanolamine including at least one C₁ to C₁₄ alkyl chain bonded to a nitrogen atom, wherein said at least one alkyl chain further includes at least one hydroxy group bonded to one of the carbon atoms in said at least one alkyl chain; b) causing a tissue paper web to be adhered to the surface of said dryer; and c) removing the web from the dryer via a blade.

2) A process according to claim 1 wherein said alkanolamine salt is present in any amount between 50 ppm and 5000 ppm based upon the total weight of said composition.

3) A process according to claim 1 wherein said alkanolamine is selected from the group consisting of: mono-ethanolamine, di-ethanolamine, tri-ethanolamine, mono-isopropanolamine, di-isopropanolamine, and tri-isopropanolamine.

4) A process according to claim 1 wherein the ratio of styrene to methacrylic acid content of said co-polymer is any amount between 10:90 to 90:10 on a weight basis.

5) A process according to claim 1 wherein the ratio of styrene to methacrylic acid content of said co-polymer is any amount between 25:75 to 75:25 on a weight basis.

6) A process according to claim 1 wherein the ratio of styrene to methacrylic acid content of said co-polymer is any amount between 40:60 to 60:40 on a weight basis.

7) A process according to claim 1 wherein the glass transition temperature of said co-polymer is at least 10° C.
